(19) United States
(12) Patent Application Publication
(10) Pub. No.: US 2025/0247810 A1
(43) Pub. Date: Jul. 31, 2025

(54) Device for Tracking a Product

(71) Applicant: AUTHENA AG, Zug (CH)

(72) Inventors: Matteo Panzavolta, Rüschlikon (CH); Dejan Milenovic, Horgen (CH)

(21) Appl. No.: 18/703,593

(22) PCT Filed: Oct. 21, 2022
(86) PCT No.: PCT/EP2022/079464

§ 371 Date: Apr. 22, 2024

(30) Foreign Application Priority Data
Oct. 22, 2021 (CH) CH070437/2021

(51) Int. Cl. H04W 64/00; H04W 4/38

(52) U.S. Cl. CPC H04W 64/00; H04W 4/38

(57) ABSTRACT

Device for tracking a portable product comprising: a securing means for physically associating the portable product with the device; a tamper detector configured to detect whether the portable product is physically associated with the device; a sensor system comprising one or more of: a sensor configured to measure environmental conditions or a motion sensor; a control module comprising a processor and a cellular network transceiver, wherein the control module is connected to the tamper detector and the sensor system and wherein the processor is configured to: determine location information indicative of a location of the device, using cellular information received from a cellular network using the cellular network transceiver; and transmit a status message via the cellular network to a remote server, using the cellular network transceiver, the status message comprising one or more of the following: the location information, sensor system information from the sensor system, or tamper detector information, the tamper information indicating whether the portable product is associated with the device.

### FIELD OF THE DISCLOSURE

The present disclosure relates to a device for tracking a portable product.

### BACKGROUND OF THE DISCLOSURE

Tracking devices are known which are attached, for example, to a vehicle (e.g. a truck or a ship) to monitor a shipment. These tracking devices determine a position of the vehicle using GPS, reporting the position via a mobile network. Thereby, it is possible to pinpoint a vehicle's location in real-time to determine a probable time of arrival at a particular destination, monitor vehicle speeds and driver behaviour.

Devices are also known for monitoring cold chain integrity (in particular during transit) for portable products which are sensitive to temperature, which comprise a temperature sensor for monitoring the temperature applied to the goods package. The temperature sensor readings are recorded to a data store of the device and which is read out before the portable product is used.

These and other similar known devices however all have one or more short-comings, including: inability to provide information in real-time, inability to work across multiple geographic areas, for example across multiple countries, inability to report location in some locations (for example indoors), inability to track a product for a long period of time due, and/or a lack of security mechanisms or tamper detectors which may result in the trackers or the products themselves being tampered with or diverted without this being registered.

### SUMMARY OF THE DISCLOSURE

It is an object of this disclosure to provide a device for tracking a portable product which overcomes one or more disadvantages of the prior art.

In particular, it is an object of this disclosure to provide a device for tracking a portable product which is energy efficient, easily portable, and tamper resistant.

According to the present disclosure, the above-mentioned objects are achieved by a device for tracking a portable product comprising a securing means for physically associating the portable product with the device. The device comprises a tamper detector configured to detect whether the portable product is physically associated with the device. The device comprises a sensor system comprising a sensor configured to measure environmental conditions and/or a motion sensor. The device comprises a control module comprising a processor and a cellular network transceiver. The control module is connected to the tamper detector and the sensor system. The processor is configured to determine location information indicative of a location of the device, using cellular information received from a cellular network using the cellular network transceiver. The processor is configured to transmit a status message via the cellular network to a remote server, using the cellular network transceiver, the status message including status information comprising one or more of the following: the location information, sensor system information from the sensor system, or tamper detector information, the tamper information indicating whether the portable product is associated with the device.

The portable product is, for example, a consumer good that is small and light enough to be picked up by hand. By way of its portability, the portable product is more susceptible to being lost, stolen, or otherwise misplaced. Especially for valuable, dangerous, and/or confidential products, or products to which particular attention and care is directed, there is an interest in ensuring the products do not go missing (are not diverted). Transit is a period during a product's lifetime in which neither the manufacturer of the product, nor its intended recipient, is in full and complete knowledge of the portable product's status, including its location. Therefore, there is a need to provide the herein described device to track the portable product. Further, as it is not always deemed sufficient to track a collection of products, for example by way of tracking a vehicle (e.g. a truck or a ship), a container, or otherwise a collection of multiple products, the herein described device is configured to track a single portable product.

In an embodiment, the portable product is a pharmaceutical product, in particular a pharmaceutical product comprising contents including an active substance intended for use as a drug in humans, for example to diagnose, cure, treat, or prevent disease. For example, the pharmaceutical product is a bottle comprising the active substance.

The device being physically associated with the portable product means that if the device is moved, the portable product also moves (and vice-versa). Depending on the embodiment, the device is physically associated with the portable product in one or more ways. The device is physically associated with the portable product using the securing means which ensure a physical connection between the device and the portable product.

The cellular network transceiver is configured for communication with cellular networks, for example a mobile phone network. Depending on the embodiment, the cellular network transceiver is configured to communicate with a cellular network using one or more digital cellular technologies (e.g. GSM, GPRS, CDMA2000, EDGE, and/or UTMS).

In an embodiment, the securing means comprise an attachment mechanism for securely attaching the device to the portable product device. The attachment mechanism is configured for removable attachment with the portable product. In an embodiment, the attachment mechanism is disengaged or able to be disengaged (for example by a user or a separate apparatus).

In an embodiment, the device receives and/or generates a release message configured to disengage the securing means, specifically the attachment mechanism, such that the device and the portable product are no longer physically associated.

In an embodiment, the device is configured to monitor the physical association between the device and the portable product using the tamper detector, such that a physical disassociation, for example due to tampering, is detected in the device.

In an embodiment, the securing means comprises a receptacle for the portable product. The receptacle is configured, for example, to partially or fully enclose the portable product, which portable product is partially or fully inserted in the receptacle, respectively. In an example, the receptacle receives the portable product in part or in whole, and the securing means further comprises a lid, top, collar, gasket, sleeve and/or other retaining means configured to securely hold the portable product in the receptacle.

The receptacle is, for example, implemented as a container or a holder that serves as a repository for the portable product. In other words, the receptacle acts as a storage compartment which partially or fully encloses the portable product. The portable product can be a single item or a collection of items.

The receptacle preferably serves the purpose of both transporting the portable product along with the device (i.e., the portable product moves when the device moves), and also containing the portable product at least partially (i.e., at least two sides of the portable product are enclosed by the receptacle) such that a relative movement between the device and the portable product is restricted at least by one degree of freedom.

In an embodiment where the portable product is a bottle, the receptacle is configured such that the bottle engages in an interference fit with an elastic gasket of the receptacle for securely holding the bottle in the receptacle.

In an embodiment where the portable product is a bottle comprising a lid, the securing means is designed to secure the bottle and/or its contents.

In an embodiment, the tamper detector comprises a presence detector configured to detect whether the portable product is located in the receptacle, in particular whether the product is in an inserted state. Depending on the embodiment, the presence detector comprises one or more sensors and is configured to transmit a signal indicating whether the portable product is located in the receptacle. In an embodiment, the presence detector is configured to transmit a signal depending on a change of state of the portable product, in particular a change of state from an inserted state in which the portable product is located in the receptacle to a non-inserted state in which the portable product is not located in the receptacle.

In an embodiment, the presence detector comprises a light detector and/or a switch. The light detector is configured to detect a change in light levels, in particular inside the receptacle. The switch is configured to detect a change in contact pressure resulting from the portable product being inserted into or removed from the receptacle.

The change in light levels is indicative of the portable product being removed from the device. In particular, a change in light levels from dark to light is indicative of the portable product being removed from the device. Depending on the embodiment, the light detector is configured to detect a change in light levels exceeding a particular threshold within a pre-defined period of time, wherein the particular threshold and the pre-defined period of time are selected according to the particular embodiment of the invention. Specifically, the particular thresholds and the pre-defined period of time are configured such that natural changed in ambient light conditions are not registered as the portable product being removed from the device. Further, the light detector is positioned such that ambient light does not, or does not largely reach the light detector when the portable product is in an inserted state.

In an embodiment, the presence detector further comprises a light source (e.g., an LED), preferably having a predefined wavelength, configured to emit light towards the portable product. The presence detector, using the light detector, is configured to detect a change in the light level, in particular of light of the predefined wavelength, and thereby to determine whether or not the portable product is still physically associated with the device. The detect light comprises in particular light emitted by the light source and reflected by the portable product, The switch is configured to detect whether the portable product is removed from the receptacle, in particular by detecting a change in contact pressure. Depending on the embodiment, the switch is configured such that the portable product engages with the switch when the portable product is in an inserted state, such that the switch registers a change when the portable product is removed from the device. In another embodiment, the switch is configured such that the portable product engages with the switch when the portable product is inserted and/or removed from the device.

Depending on the embodiment, a removal of the portable product is registered when the switch and/or the light detector detect removal of the portable product. In a preferred embodiment, the switch detects removal of the portable product, the light detector further verifying that the portable product has been removed.

In an embodiment, the presence detector further comprises an inductance sensor configured to determine a change in inductance associated with the portable product being physically associated with the device. The change in inductance may be directly due to the portable product itself influencing an inductance measured by the inductance sensor, or due to the presence of the portable product altering the device, for example by moving, shifting, or flexing a part of the device (in particular a metallic part of the device) resulting in a change in the inductance. The change in inductance can also be indicative of the portable product being partially removed from the device, e.g. in the case where the portable product is a liquid or a collection of items.

In an embodiment, the presence detector further comprises a capacitance sensor configured to determine a change in capacitance associated with the portable product being physically associated with the device. The change in capacitance may be directly due to the portable product itself influencing a capacitance measured by the capacitance sensor, or due to the presence of the portable product altering the device, for example by moving, shifting, or flexing a part of the device (in particular a metallic part of the device) resulting in a change in the capacitance. The change in capacitance can also be indicative of the portable product being partially removed from the device, e.g. in the case where the portable product is a liquid or a collection of items.

In an embodiment, the sensor system comprises a temperature sensor and/or a humidity sensor. The temperature sensor is configured to determine the temperature of the portable product and/or the temperature of the environment. The humidity sensor is configured to determine the humidity of the environmental air. The processor is further configured to determine whether environmental conditions are within pre-determined environmental condition thresholds. The environmental conditions are defined using one or more temperature thresholds which define one or more temperature ranges. In an example, the environmental conditions are further defined using one or more humidity thresholds which define or more humidity ranges. The processor is configured to transmit, as part of the status message, an environmental condition alarm message if the environmental conditions are not within the pre-determined environmental condition thresholds. In an embodiment, the pre-determined environmental condition thresholds are further dependent on time, such that the processor is configured to determine whether the pre-determined environmental condition thresholds have not been met for a period of time, which period of time may depend on the environmental conditions. For example, if the temperature exceeds a defined temperature threshold by a small amount for only a short period of time, the processor may be configured not to transmit the environmental condition alarm message. In this manner, the pre-determined environmental condition thresholds better reflect the nature of active substances, which for example show a temperature dependent degradation.

In an embodiment, the sensor system comprises a barometric pressure sensor configured to measure an atmospheric pressure. The processor is further configured to determine whether the device is airborne, for example by being transported by an airplane, by detecting a drop in the atmospheric pressure below a pre-determined barometric pressure threshold. The processor is further configured to deactivate the cellular network transceiver while the device is airborne.

Depending on the embodiment, the processor is configured to determine whether the device is airborne by detecting a rate of change of the atmospheric pressure indicative of an airplane gaining altitude. The processor is further configured to deactivate the cellular network transceiver while the device is airborne.

Depending on the embodiment, the processor is further configured to determine whether the device is located at or near an airport, in addition to determining whether the device is airborne, prior to deactivating the cellular network transceiver.

In an embodiment, the motion sensor comprises an accelerometer. The accelerometer is configured to measure a movement signal of the device. The processor is further configured to receive, from the accelerometer, the movement signal. The processor is configured to determine, using the movement signal, whether the device is moving. The processor is configured to change a period of time between transmissions depending on whether the device is moving or not. In particular, the processor is configured to transmit a plurality of status messages, using the cellular network transceiver, with a first pre-determined wait period between successive status messages if the device is not moving and transmit the plurality of status messages with a second pre-determined wait period between successive status messages if the device is moving. The first pre-determined wait period is longer than the second pre-determined wait period. In this manner, the device is configured to save energy by reducing a frequency of transmissions while the device is stationary.

In an embodiment, the control module comprises a memory. The processor is further configured to record a log file entry to the memory, the log file entry comprising the sensor system information, the tamper detector information, and/or the location information. The log file entry may further comprise a time-stamp. The log file entry may be stored in the memory in a table.

In an embodiment, the processor is further configured to determine whether the cellular network transceiver is connected to the cellular network. The processor is configured to designate currently recorded log file entries as unsent if the cellular network transceiver is not connected to the cellular network. The processor is configured to transmit the unsent log file entries as part of one or more status messages, once the cellular network transceiver reconnects to the cellular network. In this manner, the device, in particular the processor, is configured to ensure that currently recorded log file entries are transmitted as soon as the cellular network transceiver reconnects to the cellular network, ensuring that no log file entries remain unsent such that the log file entries received by the server are gap-free.

In an embodiment, the device further comprises a battery connected to the control module. The processor is configured to receive a battery level indicator, indicative of a remaining battery level of the battery. The processor is configured to transmit, as part of the status message, the battery level indicator. Thereby, the remote server obtains a record of the battery level of the device.

In an embodiment, the battery level indicator indicates a remaining battery level as a percentage of a full battery level and/or as an absolute energy capacity (e.g., in milli-Watt hours). The battery level indicator further comprises, depending on the embodiment, a remaining operating time of the device (e.g., in minutes, hours, and/or days). The battery level indicator further comprises, depending on the embodiment, a remaining operating time of the secondary in a current operating configuration of the secondary device as well as at least one other operating configuration of the secondary device. The operating configurations of the device relate to, for example, a period between transmitting status messages.

In an embodiment, the device further comprises an inductive charging circuit connected to the battery configured to receive electrical energy for charging the battery. The inductive charging circuit is preferably configured in a base-part of the device such that the device is rechargeable via a surface on which the device is placed.

In an embodiment, the control module comprises an ultra-wideband transceiver. The ultra-wideband transceiver is configured to receive an ultra-wideband message as part of an ultra-wideband transmission from a further device. For ease of understanding, the device will be referred to as the primary device and the further device(s) as the secondary device(s) throughout parts of this disclosure relating to a plurality of interacting devices. The secondary device is a device configured to track a portable product physically associated with the secondary device. Preferably, the secondary device comprises the same features as the primary device according to an embodiment or combination of embodiments of the primary device as described herein. The ultra-wideband message comprises status information of the secondary device comprising, for example, a device identifier of the secondary device, device sensor system information from a sensor system of the secondary device and/or device tamper detector information from a tamper detector of the secondary device. The processor of the primary device is further configured to transmit, using the cellular network transceiver, the status information of the secondary device as part of one or more relay messages transmitted by the cellular network transceiver of the primary device, via the cellular network, to the remote server. Specifically, the relay message comprises the device identifier of the secondary device, the sensor system information from the secondary device, and/or the device tamper detector information from the secondary device. In this manner, the primary device acts as a relay node for relaying status information of the secondary device to the remote server, such that the secondary device is not required to communicate directly with the remote server using the cellular network.

In an embodiment, the processor of the primary device is further configured to determine, using the ultra-wideband message, whether the secondary device is located within a pre-defined proximity range of the primary device. The relay messages transmitted by the primary device further comprise a proximity indicator indicating whether the secondary device is located within the pre-defined proximity range.

Determining whether the secondary device is located within the pre-defined proximity range comprises determining, in the primary device, a distance between the primary device and the secondary device. The distance is determined, for example, using time-of-flight considerations and/or time-difference-of-arrival considerations as known in the art.

In an embodiment, the ultra-wideband transceiver of the primary device comprises a plurality of ultra-wideband antennas, in particular three antennas, arranged such that a position of the secondary device is determined in the primary device, which position is a position of the secondary device relative to the primary device. In particular, the ultra-wideband transceiver of the primary device is configured to receive an ultra-wideband message from the secondary device at each of the plurality of antennas of the primary device, the ultra-wideband transceiver and/or the processor of the primary device being configured to determine the position of the secondary device using a time-difference of arrival of the ultra-wideband message at each of the antennas. In an embodiment, the relay message transmitted by the primary device via the cellular network transceiver further comprises the position of the secondary device. In this manner, the remote server is enabled to determine a spatial relationship between the primary device and the secondary device, which spatial relationship relates to a two-dimensional or three-dimensional arrangement of the primary device and the secondary device. Additionally, the remote server is enabled to determine an absolute position of the secondary device using the location information of the primary device and the (relative) position of the secondary device to the primary device.

In an embodiment, the primary device is configured to determine a movement direction of the secondary device with respect to the primary device using a plurality of determined positions.

In an embodiment, the processor of the primary device is configured to receive, as part of the ultra-wideband message from the secondary device, a device battery level indicator of the secondary device. The processor is configured to determine, using the device battery level indicator of the primary device and the device battery level indicator of the secondary device, whether the primary device is to transmit the status information of the secondary device to the remote server on behalf of the secondary device, in particular to maximize an overall operating time of both devices, and to transmit the status information of the secondary device to the remote server if this is the case. If the processor of the primary device determines that the secondary device is to transmit the status information of the primary device instead, the processor of the primary device is configured to transmit the status message to the secondary device for forwarding to the remote server. In this case, the secondary device acts as the relay node, transmitting the status information of the primary device in a relay message to the remote server.

In such a manner, the primary device and the secondary device determine between themselves which particular device of the two devices has more operating time left. The particular device with more operating time left is designated as the relay node between both devices and the remote server. In some embodiments it is foreseen that the role of the relay node will switch back and forth between the primary device and the secondary device one or more times because the device battery level of both devices will deplete at differing rates, depending on whether they are currently the relay node or not.

In an embodiment, using the device battery level indicator comprises determining, in the processor of the primary device, whether the secondary device has more operating time left than the primary device and, if the secondary device has more operating time left, transmitting the status message to the secondary device using the ultra-wideband transceiver instead of transmitting the status message to the remote server using the cellular network transceiver.

The particular device designated as the relay node receives the status message from the device not designated as the relay node and forwards the status message to the remote server. Thereby, only one device transmits messages directly to the remote server via the cellular network, and inter-device communication takes place using ultra-wideband messages. This reduces traffic on the cellular network and also reduces an overall power consumption of the devices, as the ultra-wideband messages transmitted between the devices consume comparatively less power than the messages transmitted over the cellular network.

In an embodiment featuring a plurality of secondary devices, the processor of the primary device is configured to determine whether the primary device has more operating time left than any of the further devices and to transmit the status message using the cellular network transceiver only if the device has more operating time left than any of the further devices. The processor determines whether the device has more operating time left by receiving one or more ultra-wideband messages from one or more further devices, which ultra-wideband messages comprise information indicating the operating time of one or more further devices. If the device has less operating time left than any of the further devices, the processor is configured to transmit the status message, using the ultra-wideband transceiver, to the further device with the highest remaining operating time.

Depending on the embodiment, the status message is transmitted directly to the secondary device with the highest remaining operating time, or is transmitted indirectly, via one or more intermediary secondary devices, to the secondary device with the highest remaining operating time.

In an embodiment, the primary device is configured to establish an ultra-wideband communications network between the primary device and one or more secondary devices. The primary device and the one or more secondary devices are configured to exchange ultra-wideband messages with each other. The primary device in particular is configured to receive an ultra-wideband message comprising a device identifier of a given secondary device, sensor system information from the given further device, and/or tamper detector information from the given further device. Depending on the embodiment, additional status information is also exchanged in the ultra-wideband messages (e.g. a product identifier of the portable product physically associated with the further device). Depending on the embodiment, the primary device is configured to determine a distance, a position, and/or a movement direction of the given secondary device. Further, in an embodiment, the primary device is configured to transmit, as part of the relay messages, the distance, the position, and/or the movement direction of the secondary devices.

In an embodiment, the primary device and the secondary devices are configured such that the ultra-wideband communications network is established in a star topology in which the primary device communicates directly with the secondary devices using ultra-wideband messages. The primary device therefore acts as a central node in the ultra-wideband communications network, while the secondary devices act as edge nodes. The primary device is configured to transmit relay messages using the cellular network transceiver to the remote server, which relay messages include status information received from the further devices. Depending on the embodiment, the primary device is configured to determine the distance, the position, and/or the movement direction of the secondary devices using the ultra-wideband messages received from the secondary devices and to transmit as part of the relay messages, the distance, the position, and/or the movement direction of the secondary devices.

In an embodiment, the primary device and the secondary devices are configured such that the ultra-wideband communications network is established in a mesh topology in which at least one secondary device communicates with the primary device indirectly via at least one intermediary secondary device. In this embodiment, the one or more secondary devices intermediary between a given secondary device and the primary device are configured to forward status information received from the given secondary device to the primary device.

In an embodiment, the processor of the device is further configured to receive, using the cellular network transceiver, from the remote server, a product identification number. The processor is configured store, in the memory, the product identification number. The processor is configured to transmit the status message including the product identification number. The product identification number is received in the device, for example, at the same time that the portable product is physically associated with the device.

In an embodiment, the cellular network transceiver comprises a narrowband Internet of things (NB-IoT) module and/or an enhanced General Packet Radio Service (GPRS) module.

In an embodiment, the control module further comprises an electronic SIM module storing a plurality of connectivity profiles. The processor is further configured to activate a particular connectivity profile depending on the cellular information received from the cellular network. The processor is configured to transmit the status message using the particular connectivity profile.

In an embodiment, the processor is further configured to determine, using the cellular information received from the cellular network, a geographic location of one or more cellular stations to which the cellular network transceiver is connected, a round-trip time between the device and the cellular station(s), and/or a signal strength of a transmission received from the cellular station(s).

In an embodiment, processor is further configured to determine, using the cellular information received from the cellular network, cellular station identification information of one or more cellular stations to which the cellular network transceiver is connected, in particular wherein the cellular station identification information relates to an identifier of the cellular station(s). The cellular station identification information is used to determine the location information. In an embodiment, the cellular station identification information corresponds to the location information.

In an embodiment, the cellular station identification information received from the cellular network, in particular the identifier of the cellular station, comprises, depending on the digital cellular technology of the cellular network, a serving Cell ID (CID), E-UTRAN Cell Identity, and/or a location area code (LAC). For example, the serving Cell ID is a number used to identify a base transceiver station (BTS) or sector of a BTS within a LAC of the cellular network.

The location information comprises, depending on the embodiment, geographic coordinates indicative of a physical location of the device, a serving Cell ID, a E-UTRAN Cell Identity, a LAC, a round-trip time, and/or a signal strength.

Depending on the embodiment, either the remote server or the device itself is configured to store and/or access a Cell ID database which provides geographic coordinates of the Cell identified by the Cell ID, in particular of the base transceiver station. The geographic coordinates of the device are therefore made available to the remote server either directly (i.e. in that the location information received from the device comprises the geographic coordinates), or indirectly (i.e. in that the location information received from the device enables the remote server to determine the geographic coordinates).

In an embodiment, the processor of the device is configured to determine, using the cellular information received from the cellular network, whether the cellular network supports a low-power wide-area network protocol (LP-WAN), in particular a narrowband Internet of Things protocol (NB-IoT). The processor is configured to transmit the status message using the LP-WAN protocol if the cellular network supports the LP-WAN protocol. The processor is configured to transmit the status message using a short message service (SMS) of the cellular network if the cellular network does not support the low-power wide-area network protocol. In this manner, the processor of the device switches networks depending on availability, with a preference for the LP-WAN.

In an embodiment, the memory of the device is configured to store a private key and the processor is further configured to digitally sign the status message using the private key and to transmit the status message, via the cellular network, to a node of a distributed system, in particular a Blockchain system. In an embodiment where the device is configured to transmit relay messages, the device is further configured to digitally sign the relay messages using the private key.

In an embodiment, the processor of the device is further configured to receive, via the cellular network, a release message from the remote server. The device is configured to disengage the securing means upon reception of the release message. Disengaging the securing means comprises, in an embodiment, driving an actuator of the securing means such that the portable product is no longer physically associated, in particular securely attached, to the device.

### BRIEF DESCRIPTION OF THE DRAWINGS

The present disclosure will be explained in more detail, by way of example, with reference to the drawings in which:

FIG. 1: shows a diagram illustrating a device for tracking a portable product;

FIG. 2: shows a block diagram illustrating a device for tracking a portable product;

FIG. 3: shows a block diagram illustrating securing means for the device;

FIG. 4: shows a block diagram illustrating a tamper detector for the device;

FIG. 5: shows a block diagram illustrating a sensor system for the device;

FIG. 6: shows a block diagram illustrating a control module for the device;

FIG. 7: shows a block diagram illustrating processor implementing a number of services for the control module of the device;

FIG. 8: shows a block diagram illustrating a primary device and several connected secondary devices;

FIG. 9: shows a perspective view of a 3D model of a device according to an embodiment; and

FIG. 10: shows a section view of a 3D of a device holding a portable product according to an embodiment.

### DETAILED DESCRIPTION OF EMBODIMENTS

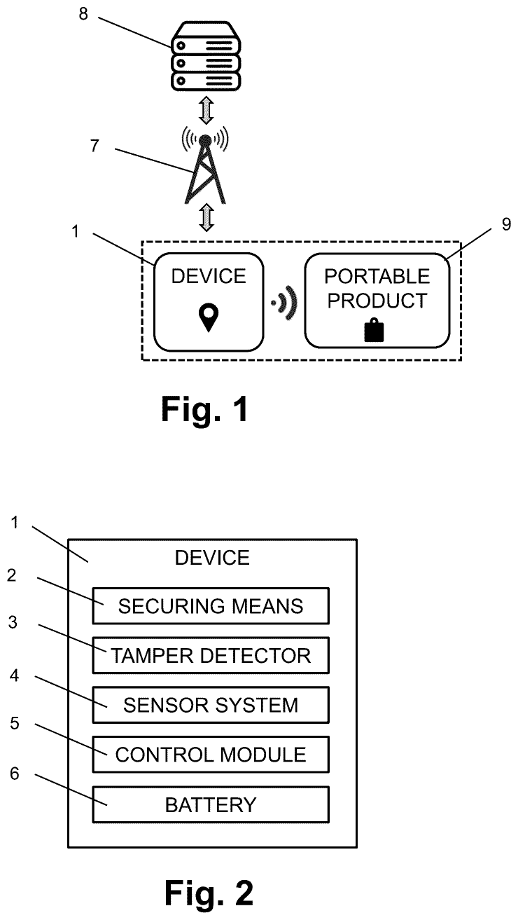

FIG. 1 shows a device 1 physically associated with a portable product 9. The portable product 9 is either attached to the device 1 or (at least partially) enclosed by the device 1, such that if the device 1 is moved, the portable product 9 is also moved. Further, if the portable product 9 is physically dissociated with the device 1, for example by detachment or removal, the device 1 registers the detachment. The detachment is registered by the device 1, either by determining that the portable product 9 itself is no longer physically associated with the device 1 or by determining that securing means 2 of the device 1 used to maintain the physical association have been tampered with. The dotted lines indicate that the device 1 and the portable product 9 are, in an embodiment, integrated, at least such that the device 1 partially or fully encloses the portable product 9.

The device 1 is configured to monitor a status of the portable product 9 using a tamper detector 3 and sensor system 4 as described in more detail with reference to FIGS. 2-5 below.

The device 1 regularly transmits status messages to a remote server 8 via a cellular network 7. Additional networks, including for example the Internet, may also be interposed between the device 1 and the remote server 8, in particular between the cellular network 7 and the remote server 8.

The remote server 8 can comprise a plurality of servers and/or other computing equipment and, depending on the embodiment, is a cloud-based server. The remote server 8 is configured to receive the status messages from the device 1 and store them, for example in a database. The remote server 8 is further configured to analyze the status messages and provide summaries and/or reports, to other computer systems or users, which users for example include a manufacturer of the device 1 and/or the portable product 9, a customer of the portable product 9, a transporter of the portable product 9, and/or the public. The summaries and/or reports contain information relating to the location history of the portable product 9, environmental condition history of the portable product, and information relating to whether the portable product 9 was tampered with.

The cellular network 7 is, for example, a GSM, GPRS, CDMA, UTMS, or EDGE cellular network.

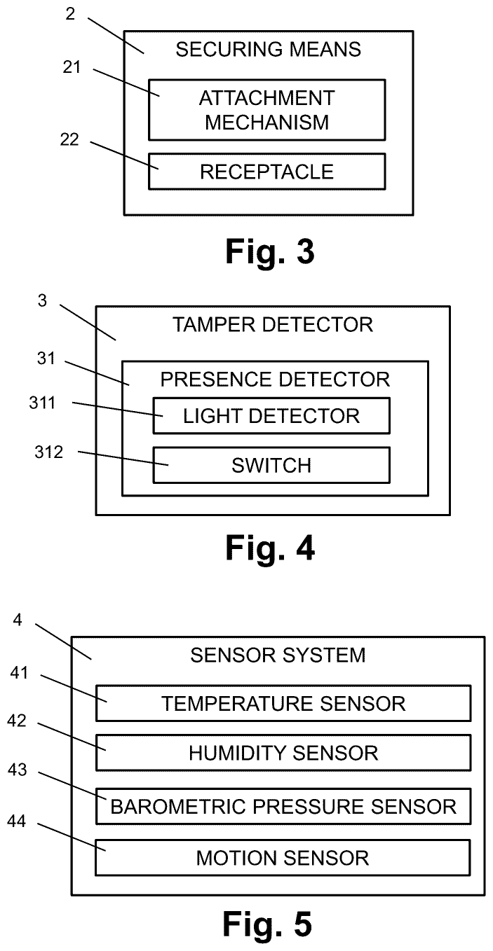

FIG. 2 shows a device 1 comprising securing means 2. The securing means 2 physically associate the device 1 with the portable product 9, for example by establishing and maintaining a physical connection. Alternatively, or additionally, the device 1 itself provides the securing means 2 by way of forming an enclosure or container for physically enclosing respectively containing the portable product 9. The securing means are described in more detail with reference to FIG. 3.

The device 1 comprises a tamper detector 3 configured to detect if the portable product 9 is tampered with. For example, the tamper detector 3 is configured to detect if the portable product 9 is physically disassociated with the device 1 and/or if the portable product 9 is manipulated, accessed or used without authorization, or otherwise has its integrity compromised. The tamper detector is described in more detail with reference to FIG. 4.

The device 1 comprises a sensor system 4 configured to monitor the portable product 9. In particular, environmental conditions are monitored to detect whether the portable product 9 is exposed to environmental conditions which may compromise the integrity of the portable product 9, in particular in embodiments where the portable product 9 comprises one or more substances which degrade, spoil, or otherwise lose efficacy after being subject to temperature and/or humidity levels outside a specified range. The sensor system 4 is described in more detail with reference to FIG. 5.

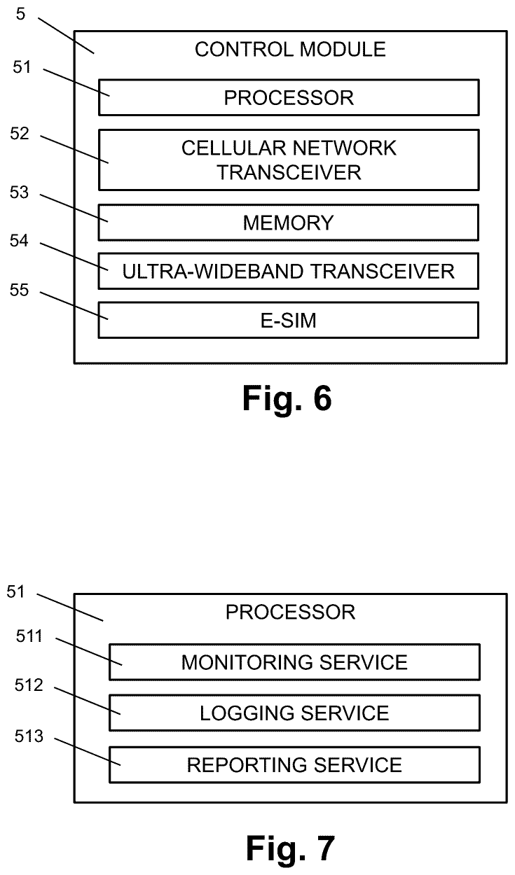

The device 1 comprises a control module 5 comprising one or more electronic circuits configured to perform one or more functions and/or steps. The control module 5 is connected to the tamper detector 3, the sensor system 4, and optionally the securing means 2. The control module 5 is powered by a battery 6. The control module 5 is described in more detail with reference to FIG. 6. The battery 6 is preferably rechargeable and, depending on the embodiment, is connected to a charging port and/or an inductive charging circuit which are configured to receive electrical energy for recharging the battery 6.

In an embodiment including a charging port, the charging port is, for example, a Universal Serial Bus (USB) port further configured for data communication with the control module 5.

FIG. 3 shows a block diagram illustrating securing means 2. The securing means 2 are, as described herein, configured for physically associating the device 1 with the portable product 9. To this end, the portable product 9 is either connected with the device 1 using an attachment mechanism 21 and/or is at least partially enclosed by a receptacle 22 of the device 1.

In an embodiment, the attachment mechanism 21 is a removable attachment mechanism 21 such that the portable product 9 can be physically disassociated from the device 1. The physical association and the physical disassociation using the attachment mechanism 21 takes place either via user intervention (i.e. a user attaching and detaching the portable product 9 to the device 1 using the attachment mechanism 21) and/or via an actuator of the attachment mechanism 21 configured to secure the portable product 9 to the device 1.

FIG. 4 shows a block diagram illustrating a tamper detector 3. In an embodiment, the tamper detector comprises a presence detector 31. The presence detector 31 is configured to detect whether the portable product 9 is physically associated with the device 1. The presence detector 31 transmits a presence signal to the control module 5 indicating whether the portable product 9 is physically associated with the device 1.

Depending on the embodiment, the presence detector 31 comprises a light detector 311 and/or a switch 312.

The light detector 311 is configured to measure light levels and is arranged in the device 1 such that a physical disassociation of the portable product 9 and the device 1 causes the measured light levels to change. For example, the light detector 311 is arranged such that a physically associated portable product 9 obscures or shields the light detector 311 from ambient light, such that when the portable product 9 is physically disassociated the ambient light falls on the light detector 311. As such, the light detector 311 measures a first light level when the portable product 9 is physically associated with the device 1, and a second light level when the portable product 9 is not physically associated with the device 1, the first light level being lower than the second light level. The light detector 311 is configured to generate a signal indicating that the portable product 9 is no longer physically associated with the device 1 if the light level exceeds a defined light level threshold and/or a rate of change of the light level increase exceeding a defined light level ramp rate threshold. The defined light level threshold lies between the first light level and the second light level.

The light detector 311 comprises, for example, a photoconductor, a photovoltaic element, a phototransistor, and/or a photodiode.

In an embodiment, the light detector 311 is configured and/or arranged to account for and/or mitigate the effect of gradual changes in ambient light due to natural day and night variation. Additionally, the light detector 311 is similarly configured and/or arranged to account for and/or mitigate the effect of changes in indoor lighting. This ensures a reliable and robust presence detection using the light detector 311.

The switch 312 is configured to transmit a switch signal depending on whether the portable product 9 is physically associated with the device 1 or not. In particular, the switch 312 is configured to transmit a switch signal if the portable product 9 is physically disassociated from the device 1. The switch 312 is preferably arranged such that the portable product 9 is in physical contact with the switch 312 when the portable product 9 is physically associated with the device 1.

In an embodiment, the switch 312 comprises a micro switch comprising a movable element which closes an electric circuit when actuated.

In an embodiment, the switch 312 comprises a pressure sensor, for example a piezoelectric pressure sensor.

FIG. 5 shows a block diagram illustrating a sensor system 4. Depending on the embodiment, the sensor system 4 comprises a temperature sensor 41, a humidity sensor 42, a barometric pressure sensor 43, and/or a motion sensor 44. Depending on the embodiment, the sensor system 4 is one unit or comprises several units arranged at different places in the device 1. The sensor system 4 is connected to the control module 5 and configured to transmit to the control module 5 sensor system information.

In an embodiment, the sensor system 4 is further configured to receive, from the control module 5, configuration settings. The configuration settings configure the sensor system 4, for example a sampling rate of the sensors.

In an embodiment, the temperature sensor 41 is configured to measure an ambient temperature. In an embodiment, the temperature sensor 41 is configured to measure a temperature of the portable product 9.

The humidity sensor 41 is configured to determine an air humidity.

The barometric pressure sensor 43 is configured to determine a barometric pressure. As explained herein, the barometric pressure is used to determine an altitude and/or a rate of change of altitude of the device 1. The altitude and/or the rate of change of altitude is used to determine whether the device 1 is airborne or not.

The motion sensor 44 is configured to determine a movement of the device 1. In an embodiment, the motion sensor 44 is an accelerometer, in particular a three-axis accelerometer.

FIG. 6 shows a block diagram illustrating a control module 5. The control module 5 is connected to other electrical components of the device 1, in particular the tamper detector 3, the sensor system 4, the battery 6, and optionally the securing means 3.

The control module 5 comprises a processor 51, such as a microprocessor or a SoC (System on a Chip). The processor 51 is configured to carry out one or more steps and/or functions as described herein.

The control module 5 comprises a cellular network transceiver 52. The cellular network transceiver 52 is configured for communication with a cellular network 7 and comprises analog and/or digital circuitry and one or more antennas. In particular, the cellular network transceiver 52 is configured for wireless communication using a cellular radio communication standard (e.g. GSM, GPRS, CDMA2000, EDGE, and/or UTMS). Further, the cellular network transceiver 52 is preferably configured for wireless communication using a narrowband Internet of things (NB-IoT) standard and/or a low power wide area network (LP-WAN) standard.

The control module 5 comprises a memory 53. The memory 53 comprises volatile and/or non-volatile storage media such a random access memory and/or flash memory and is configured to store software and/or data related to the steps and/or functions described herein.

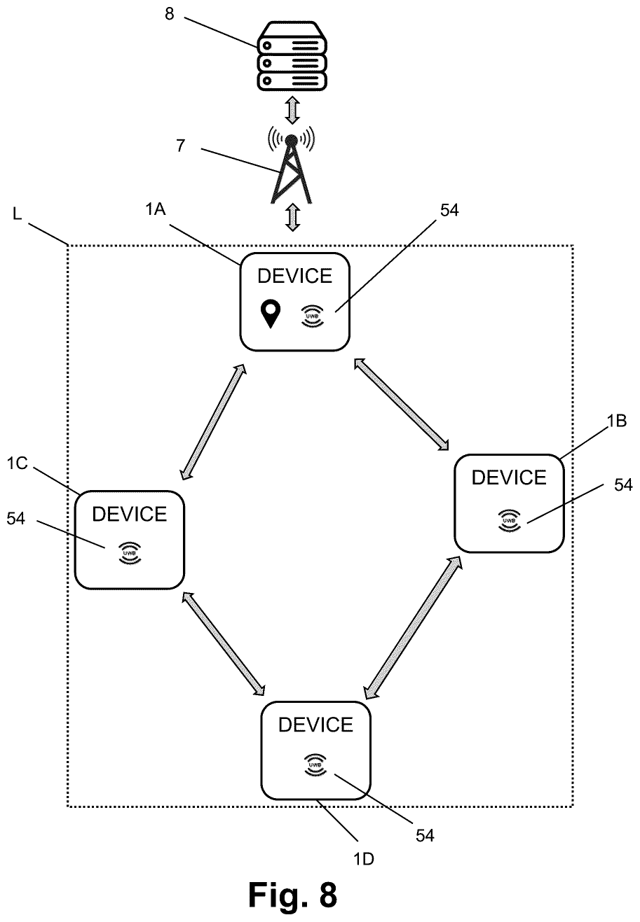

In an embodiment, the control module 5 comprises an ultra-wideband transceiver 54 configured to communicate with one or more further devices (also referred to as secondary devices) by transmitting and/or receiving one or more ultra-wideband messages. The ultra-wideband transceiver 54 is configured to determine a distance between the device 1 and further devices, as explained below in more detail with reference to FIG. 8.

The control module 5 comprises one or more subscriber identity modules (SIM). In an embodiment, the control module comprises an electronic subscriber identity module (E-SIM) 55 configured to store one or more connectivity profiles (e.g. subscriber identity profile and/or a mobile network operator (MNO) profile). In particular, the E-SIM 55 securely stores one or more international mobile subscriber identity (IMSI) numbers and therewith related digital keys. The E-SIM 55 enables the device 1, specifically the cellular network transceiver 52, to communicate using a plurality of cellular networks 7 operated by a plurality of different network operators, thereby enabling the device 1 to communicate while located in multiple countries. For example, the E-SIM 55 is realised as an embedded universal integrated circuit card (eUICC).

The control module 5 is configured to activate a particular connectivity profile depending on the cellular information received from the cellular network 7. In an embodiment, the control module 5 is configured to receive, for example via the cellular network 7, a connectivity profile, and to store the connectivity profile in the E-SIM 55.

FIG. 7 shows a block diagram illustrating a number of services which are performed by the processor 51. The services relate to one or more steps and/or functions performed in the processor 51. The services include a monitoring service 511, a logging service 512, and/or a reporting service 513. In an embodiment, the services are implemented as separate processes.

The monitoring service 511 is configured to receive information from various other electronic components of the device 1. In particular, the monitoring service 511 is configured to continuously or periodically receive information from the various electronic components of the device 1, including the securing means 2, the tamper detector 3, and/or the sensor system 4. The information may be polled (i.e. received on request) and/or received without explicit polling. In particular, the monitoring service 511 is configured to receive alert and/or warning messages from the various electronic components, in particular alert and/or warning messages related to environmental conditions no longer being within a predefined range.

In an embodiment, the monitoring service 511 is configured to further monitor the cellular network 7 using the cellular network transceiver 52. In particular, the cellular network transceiver 52 is periodically activated to receive cellular information from the cellular network 7. The cellular information includes cellular station identification information of the cellular station(s) to which the cellular network transceiver 52 is connected, a geographic location of the cellular station(s), a round-trip time, and/or a signal strength of a transmission received from the cellular station(s). Depending on the embodiment, the cellular station identification information includes a serving Cell ID (CID), E-UTRAN Cell Identity, and/or a location area code (LAC).

In an embodiment, the processor 51, in particular the monitoring service 511, is configured to adapt a polling frequency of the electronic components of the device 1, in particular the securing means 2, the tamper detector 3, the sensor system 4 and/or the cellular network transceiver 52, depending on whether the device 1 is moving or not. The processor 51 is configured to determine whether the device 1 is moving or not using an output of the motion sensor 44. Specifically, the processor 51 is configured to poll the electronic components of the device 1 with a first polling frequency if the device 1 is stationary and with a second polling frequency if the device 1 is in motion, the first polling frequency being less than the second polling frequency. The polling frequency of each electronic component of the device 1 may be adapted individually. The adaptive polling frequency reduces a power consumption of the device 1.

For example, if the device 1 is stationary, the cellular network transceiver 52 is polled once every hour, while if the device 1 is in motion, the cellular network transceiver 52 is polled once every minute.

In an embodiment, the processor 51, in particular the monitoring service 511, is configured to detect, using the barometric pressure sensor 43, if the device 1 is airborne (for example being transported by airplane). In particular, the processor 51 detects that the device 1 is airborne if the barometric pressure is below a particular threshold pressure and/or if the rate of decrease of barometric pressure exceeds a particular threshold. If processor 51 detects that the device 1 is airborne, the processor 51 is configured to deactivate the cellular network transceiver 52. Once the processor 51 detects that the device 1 is no longer airborne, the processor 51 is configured to activate the cellular network transceiver 52.

The logging service 512 is configured to write log file entries to the memory 53. The log file entries include the status of the device 1, in particular information received from the various electronic components of the device 1, such as the securing means 2, the tamper detector 3, and/or the sensor system 4. Additionally, the log file entries include the cellular information received from the cellular network 7. The logging service 512 includes a time-stamp (for example, a UTC timestamp) with at least some of the log file entries.

The logging service 512 is configured to receive, from the reporting service 513, a message indicating whether the cellular network 7 is available and/or whether the cellular network transceiver 52 is active. If the logging service 512 receives a message indicating that the cellular network 7 is unavailable or that the cellular network transceiver 52 is not active, the logging service 512 is configured to flag subsequently received log file entries as unsent. Once the logging service 512 receives a message indicating that the cellular network 7 is again available and/or that the cellular network transceiver 52 is active, the logging service 512 is configured to provide, to the reporting service 513, the flagged log files for inclusion in one or more status messages.

In an embodiment, the logging service 512 is configured to write log file entries to the memory 53 at a pre-determined frequency (i.e. having a pre-determined period of time between log-file entries). The logging service 512 is configured to adapt the frequency of log-file entries depending on whether the device 1 is stationary or motionless, as described above in relation to the monitoring service 511.

The reporting service 513 is configured to transmit status messages to the remote server 8 via the cellular network 7. Additionally, depending on the embodiment, the reporting service 513 is configured to transmit relay messages to the remote server 8 via the cellular network 7.

In an embodiment, the reporting service 513 is configured to transmit status messages to the remote server 8 at a pre-determined frequency (i.e. having a pre-determined period of time between status message transmissions). The reporting service 513 is configured to adapt the frequency of status message transmissions depending on whether the device 1 is stationary or motionless, as described above in relation to the monitoring service 511 and the logging service 512.

In an embodiment, the reporting service 513 is configured to digitally sign the status message(s) and/or the relay message(s) using a digital credential, for example a private key belonging to a public/private key-pair (using public key cryptography). Thereby, the authenticity of the status messages can be independently verified.

In an embodiment, the memory is configured to store the private key, in particular in a protected read-only memory.

In an embodiment, the reporting service 513 transmits the signed status message and/or the relay message, via the cellular network 7, to a node of a distributed system, in particular a Blockchain system.

Thereby, the status message, which includes a record of the location and other parameters of the portable product 9, are retained in a secure and decentralized manner, which results in the records being considered substantially tamper-proof. This results in improved traceability of the portable product and greater transparency.

FIG. 8 shows a diagram illustrating a plurality of devices 1A, 1B, 1C, 1D physically associated with portable products 9 (not shown) at a location L. The device 1A is designated as the primary device 1A, while the other devices 1B, 1C, and 1D are designated as secondary devices 1B, 1C, and 1D. The devices 1A, 1B, 1C, 1D comprise ultra-wideband transceivers 54 configured to transmit and receive ultra-wideband messages from one or more other devices 1A, 1B, 1C, 1D. Further, the devices 1A, 1B, 1C, 1D are configured to determine a distance between a given transmitting device 1A, 1B, 1C, 1D and a given receiving device 1A, 1B, 1C, 1D, using for example a time of flight (ToF) calculation based on two-way ranging as is known in the art.

The devices 1A, 1B, 1C, 1D are configured to establish an ultra-wideband communication network such that all devices 1A, 1B, 1C, 1D are able to communicate with each other, either directly via a direct ultra-wideband transmission, or indirectly via an intermediary device 1A, 1B, 1C, 1D. For example, the primary device 1A communicates with secondary devices 1B and 1C directly, however communicates with secondary device 1D via either 1B or 1C, which act as relay devices. The communication network is, for example, a mesh network.

The primary device 1A is configured to transmit status messages comprising status information of the primary device 1A to the remote server 8 via the cellular network 7. The secondary devices 1B, 1C, 1D are configured to deactivate their cellular network transceivers 52, if they comprise such cellular network transceivers 52. The secondary devices 1B, 1C, 1D are configured to transmit their status information to the primary device 1A using one or more ultra-wideband messages either directly or indirectly, which primary device 1 forwards the status information to the remote server 8 in one or more relay messages. In this manner, only one particular device of the devices 1A, 1B, 1C, 1D transmits messages to the remote server 8. The particular device 1A is designated as the primary device 1A.

In an embodiment, the designation of the primary device 1A changes depending on the battery levels of the devices 1A, 1B, 1C, 1D. In particular, the device 1A, 1B, 1C, 1D with the highest remaining battery level is configured to be the primary device 1A. Due to the higher rate of power consumption of the primary device 1A, after a certain amount of time has passed, one of the secondary devices 1B, 1C, 1D, in particular the secondary device 1B, 1C, 1D with the highest remaining battery level, will become the designated primary device 1A. To this end, the devices 1A, 1B, 1C, 1D are configured to include, in the ultra-wideband messages, a battery level indicator indicating a current battery level.

In an embodiment, the primary device 1A is configured to determine a distance and/or a position of the secondary devices 1B, 1C, 1D using the one or more ultra-wideband messages. In a preferred embodiment, the ultra-wideband transceivers 54 of the primary device 1A and/or of the one or more secondary devices 1B, 1C, 1D comprise a plurality of ultra-wideband transceivers 54 and/or ultra-wideband antennas such that the position is determined using trilateration.

In an embodiment, the primary device 1A is configured to forward the relay messages further comprising a status of a particular secondary device 1B, 1C, 1D further comprising the distance and/or the position of the particular secondary device 1B, 1C, 1D. The position is a position of the particular secondary device 1B, 1C, 1D relative to the primary device 1B, 1C, 1D.

In an embodiment, the primary device 1A is configured to forward the relay message further comprising an alarm message if the distance and/or position of the particular secondary device 1B, 1C, 1D exceeds a particular distance threshold and/or the position is outside a pre-defined perimeter, respectively.

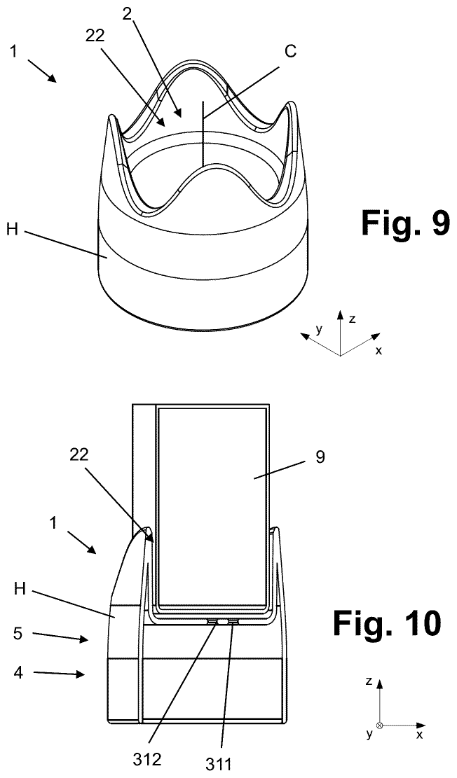

FIG. 9 shows a perspective view of a 3D model of a device 1 according to an embodiment of the present disclosure. The device 1 comprises a housing H which is substantially rotationally symmetric about a central axis C. The housing H comprises, for example, one or more pieces of an injection moulded plastic. The interior of the housing H is fitted with the various electronic components (not shown) of the device 1, including the sensor system 4, the control module 5, the battery 6. The housing H forms a receptacle 22 in the positive Z-direction which act as securing means 2 for a portable product 9 (not shown). The housing H, in particular the receptacle 22, is designed such that the portable product 9 fits snugly into the receptacle 22, thereby securing the portable product 9 through an interference fit. It is not necessary that the receptacle 22 completely receives the portable product 9, it is sufficient that only a part of the portable product 9 is inserted into the receptacle 22. Depending on the embodiment, the device 1, in particular the securing means 2, comprises a cylindrical gasket (not shown) made of an elastic material, thereby better securing the portable product 9. The device 1 further has a tamper detector 3 (not shown) which is arranged inside the receptacle 22 which detects whether the portable product 9 is attached to the device 1 or not.

The housing H may include an inductive charging circuit, which inductive charging circuit comprises a coil. The coil is configured to receive electrical power from a charging device, for example a charging mat onto which the device is placed. The coil is preferably a cylindrically shaped coil with a central axis coinciding with the centreline C of the device 1.

FIG. 10 shows a section view of the 3D model of the device 1 shown in FIG. 9, including a portable product 9 inserted into the receptacle 22. The portable product 9 has a cylindrical side-wall such that the portable product 9 fits snugly into the cylindrical recess of the receptacle 22. Depending on the embodiment, the receptacle 22 comprises a gasket or other additional retaining means to aid the retention of the portable product 9.

The various electronic components of the device 1 are fitted inside the housing H underneath the receptacle 22. The tamper detector 32 comprises a switch 312 and a light detector 311 arranged in the base of the receptacle 22. The portable product 9 contacts the switch 312 when inserted and the switch 312 is configured to detect the portable product 9. The light detector 311 is also arranged in the base of the receptacle 22, such that when the portable product 9 is inserted relatively less light falls on the light detector 311 than when the portable product 9 is not inserted.

It should be noted that, in the description, the sequence of the steps has been presented in a specific order, one skilled in the art will understand, however, that the order of at least some of the steps could be altered, without deviating from the scope of the disclosure.

1. Device for tracking a portable product comprising:
a securing means for physically associating the portable product with the device, the securing means comprising a receptacle for the portable product;
a tamper detector configured to detect whether the portable product is physically associated with the device;
a sensor system comprising one or more of: a sensor configured to measure environmental conditions or a motion sensor;
a control module comprising a processor and a cellular network transceiver, wherein the control module is connected to the tamper detector and the sensor system and wherein the processor is configured to:
determine location information indicative of a location of the device, using cellular information received from a cellular network using the cellular network transceiver; and
transmit a status message via the cellular network to a remote server, using the cellular network transceiver, the status message comprising one or more of the following: the location information, sensor system information from the sensor system, or tamper detector information, the tamper information indicating whether the portable product is associated with the device.

2. The device of claim 1, wherein the securing means comprise an attachment mechanism for securely attaching the device to the portable product.

3. The device of claim 1, wherein the securing means comprises a receptacle for the portable product, wherein the tamper detector comprises a presence detector configured to detect whether the portable product is located in the receptacle.

4. The device of claim 3, wherein the presence detector comprises one or more of: a light detector configured to detect a change in light levels inside the receptacle, a change in light levels being indicative of the portable product being removed from the device, or a switch configured to detect whether the pharmaceutical product is removed from the receptacle.

5. The device of claim 1, wherein the sensor system comprises one or more of: a temperature sensor or a humidity sensor, and wherein the processor is further configured to determine whether environmental conditions are within pre-determined environmental condition thresholds and to transmit, as part of the status message, an environmental condition alarm message if the environmental conditions are not within the pre-determined environmental condition thresholds.

6. The device of claim 1, wherein the sensor system comprises a barometric pressure sensor configured to measure an atmospheric pressure, the processor being further configured to:
determine whether the device is airborne by detecting a drop in the atmospheric pressure below a pre-determined barometric pressure threshold; and
deactivate the cellular network transceiver while the device is airborne.

7. The device of claim 1, wherein the motion sensor comprises an accelerometer configured to measure a movement signal of the device, wherein the processor is further configured to
receive, from the accelerometer, the movement signal;
determine, using the movement signal, whether the device is moving; and
transmit a plurality of status messages, using the cellular network transceiver, with a first pre-determined wait period between successive status messages if the device is not moving and with a second pre-determined wait period between successive status messages if the device is moving, wherein the first pre-determined wait period is longer than the second pre-determined wait period.

8. The device of claim 1, wherein the control module comprises a memory and the processor is further configured to record a log file entry to the memory, the log file entry comprising one or more of the following: the sensor system information, the tamper detector information, or the location information.

9. The device of claim 8, wherein the processor is further configured to:
determine whether the cellular network transceiver is connected to the cellular network;
designate currently recorded log file entries as unsent if the cellular network transceiver is not connected to the cellular network; and
transmit the unsent log file entries as part of one or more status messages, once the cellular network transceiver reconnects to the cellular network.

10. The device of claim 1, further comprising a battery connected to the control module, wherein the processor is configured to receive a battery level indicator, indicative of a remaining battery level of the battery; and transmit, as part of the status message, the battery level indicator.

11. The device of claim 10, further comprising an inductive charging circuit connected to the battery configured to receive electrical energy for charging the battery.

12. The device of claim 1, wherein the control module comprises an ultra-wideband transceiver configured to receive an ultra-wideband message from a further device, the ultra-wideband message comprising one or more of the following: a device identifier of the further device, device sensor system information from a sensor system of the further device, or device tamper detector information from a tamper detector of the further device, and the processor is further configured to:
determine, using the ultra-wideband message, whether the further device is located within a pre-defined proximity range, and
transmit, using the cellular network transceiver, the status message via the cellular network to the remote server comprising one or more of the following: a proximity indicator indicating whether the further device is located within the pre-defined proximity range, the further device identifier, the sensor system information from the further device, or the device tamper detector information from the further device.

13. The device of claim 12, wherein the processor is configured to
receive, as part of the ultra-wideband message from the further device, a device battery level indicator of the further device,
determine, using the device battery level indicator of the further device, whether the further device has more operating time left than the device, and, if the further device has more operating time left, transmit the status message to the further device using the ultra-wideband transceiver.

14. The device of claim 1, wherein the processor is further configured to:
receive, using the cellular network transceiver from the remote server, a product identification number;
store, in the memory, the product identification number; and
transmit the status message including the product identification number.

15. The device of claim 1, wherein the cellular network transceiver comprises one or more of: a narrowband Internet of things module or an enhanced General Packet Radio Service module.

16. The device of claim 1, wherein the control module further comprises an electronic SIM module storing a plurality of connectivity profiles and the processor is further configured to:
activate a particular connectivity profile depending on the cellular information received from the cellular network; and
transmit the status message using the particular connectivity profile.

17. The device of claim 1, wherein the processor is further configured to determine, using the cellular information received from the cellular network, cellular station identification information of one or more cellular stations to which the cellular network transceiver is connected, wherein the cellular station identification information relates to one or more of the following: a geographic location of the particular cellular station or a signal strength of a transmission received from the particular cellular station.

18. The device of claim 1, wherein the processor is configured to;
determine, using the cellular information received from the cellular network, whether the cellular network supports a low-power wide-area network protocol, in particular a narrowband Internet of Things protocol;
transmit the status message using the low-power wide-area network protocol if the cellular network supports the low-power wide-area network protocol; and
transmit the status message using a short message service of the cellular network if the cellular network does not support the low-power wide-area network protocol.

19. The device of claim 1, wherein the memory is configured to store a private key and the processor is further configured to digitally sign the status message using the private key and to transmit the status message, via the cellular network, to a node of a distributed system, in particular a Blockchain system.

20. The device of claim 1, wherein the processor is further configured to receive, via the cellular network, a release message from the remote server, and wherein the device is configured to disengage the securing means upon reception of the release message.
